(19) United States
(12) Patent Application Publication
(10) Pub. No.: US 2014/0246619 A1
(43) Pub. Date: Sep. 4, 2014

(54) DESIGN OF MULTI-ELECTRON LI-ION PHOSPHATE CATHODES BY MIXING TRANSITION METALS

(71) Applicant: Massachusetts Institute of Technology, Cambridge, MA (US)

(72) Inventors: Geoffroy Hautier, Bruxelles (BE); Anubhav Jain, Berkeley, CA (US); Timothy Keith Mueller, Towson, MD (US); Gerbrand Ceder, Wellesley, MA (US)

(73) Assignee: Massachusetts Institute of Technology, Cambridge, MA (US)

(21) Appl. No.: 14/152,849

(22) Filed: Jan. 10, 2014

Related U.S. Application Data
(60) Provisional application No. 61/751,643, filed on Jan. 11, 2013.

(51) Int. Cl. H01M 4/58; C01B 25/45; C01B 25/455

(52) U.S. Cl. CPC H01M 4/582; H01M 4/5825; C01B 25/455; C01B 25/45
USPC 252/182.1; 423/301; 423/306

(57) ABSTRACT

In general, the invention relates to electrode materials, e.g., novel cathode materials with high density, low cost, and high safety. A voltage design strategy based on the mixing of different transition metals in crystal structures known to be able to accommodate lithium in insertion and delithiation is presented herein. By mixing a metal active on the +2/+3 couple (e.g., Fe) with an element active on the +3/+5 or +3/+6 couples (e.g., V or Mo), high capacity multi-electron cathodes are designed in an adequate voltage window.

### CROSS-REFERENCE TO RELATED APPLICATIONS

This application claims priority to and the benefit of, and incorporates herein by reference in its entirety, U.S. Provisional Patent Application No. 61/751,643, filed Jan. 11, 2013, titled “Design of Multi-Electron Li-Ion Phosphate Cathodes by Mixing Transition Metals.”

### GOVERNMENT SUPPORT

This invention was made with government support under Contract No. DE-AC02-05CH11231 awarded by Office of Vehicle Technologies of the U.S. Department of Energy, under the Batteries for Advanced Transportation Technologies (BATT) Program Subcontract No. 6806960, and by the MRSEC Program of the National Science Foundation under award number DMR-0819762. The United States Government has certain rights in this invention.

### TECHNICAL FIELD

This invention relates generally to improved electrode materials. More particularly, in certain embodiments, the invention relates to electrode materials, electrochemical cells employing such materials, and methods of synthesizing such materials.

### BACKGROUND

A battery has at least one electrochemical cell that typically includes a positive electrode, a negative electrode, and an electrolyte. One type of battery, the lithium ion battery, has important technological and commercial applications. Lithium ion batteries are currently the dominant form of energy storage media for portable electronics, and new application areas such as hybrid and electric vehicles may further increase their demand. Improved material components for lithium ion batteries are therefore continually sought, and one such component is the battery cathode. New electrode materials have the potential to increase the capacity, rate capability, cyclability, stability, and safety of lithium ion batteries while potentially reducing their cost.

Current electrode materials such as LiCoO₂, LiFePO₄, and LiMn₂O₄ allow only 0.5-1 Li to be transferred per metal.

Strong research efforts are currently focused on finding new Li-ion battery cathode materials with high energy density, low cost, and high safety. Due to the high thermal stability and rate capability of the iron phosphate olivine LiFePO₄, phosphate-based cathode materials have been attracting significant attention from the battery community. However, current phosphate electrode materials face limitations in terms of specific energy and energy density, and a phosphate-based cathode with high energy density is greatly sought.

The energy density of a cathode is the product of two parameters: voltage and capacity. Searching for materials with higher voltage but similar capacity to iron phosphate is therefore one strategy to improve energy density. This is, for instance, the reason for the strong interest in LiMnPO₄ which provides a higher voltage at a capacity similar to LiFePO₄, but unfortunately LiMnPO₄ shows poorer rate performance.

In general though, increasing the voltage can lead to several issues in terms of electrolyte decomposition (commercial electrolytes are only stable up to around 4.5V), and higher voltage materials have generally lower intrinsic thermal stability in the charged state which causes safety concerns. The alternative strategy that has been proposed is to find phosphate materials with higher capacities. However, the capacity of phosphate materials exchanging one lithium per transition metal during the electrochemical process is intrinsically limited, and olivine LiFePO₄ is already among the one-electron phosphate cathodes with the highest volumetric and gravimetric capacities.

Another option for increasing the capacity of phosphate-based cathodes is to use multi-electron systems (i.e., materials that could cycle more than one lithium per active transition metal). However, constraints on operating voltage due to organic electrolyte stability as well as cathode structural stability have made this target difficult to reach. The choice of practical multi-electron redox couples is limited in phosphates. For the most common +2/+4 two-electron redox couple in phosphates either the +3/+4 voltage is too high for current electrolytes (e.g., Fe, Mn, Co, etc.) or the +2/+3 couple is too low in voltage (e.g., V and Mo). This voltage constraint excludes from practical use many potential phosphate-based structures that could be used on a +2/+4 couple.

As discussed above, current electrode materials, such as LiCoO₂, LiFePO₄, and LiMn₂O₄, suffer from some mixture of limited capacity, limited safety, limited stability, limited rate capability, and high cost. There is a need for electrode materials that have greater capacity, safety, rate capability, and stability than current materials, yet which are feasible for commercial production.

### SUMMARY

In general, the invention relates to electrode materials, e.g., novel cathode materials with high density, low cost, and high safety. A voltage design strategy based on the mixing of different transition metals in crystal structures known to be able to accommodate lithium in insertion and delithiation is presented herein. By mixing a metal active on the +2/+3 couple (e.g., Fe) with an element active on the +3/+5 or +3/+6 couples (e.g., V or Mo), high capacity multi-electron cathodes are designed in an adequate voltage window. The mixing strategy is applicable to LiMP₂O₇ pyrophosphates as well as LiMPO₄(OH) and LiM(PO₄)F tavorites and other suitable materials. Several new compounds of interest as cathode materials are identified. The successful preparation and testing of experimental examples of these materials are described herein.

Some embodiments discussed herein relate to multi-electron materials active in the voltage stability window of commercial electrolyte, the materials being prepared by mixing two transition metals in a crystal structure possessing adequate sites for activating a +2/+4 couple. By mixing one transition metal with a +2/+3 couple active in a voltage window of 2 to 4.5V (e.g., Co, Fe, Mn or Cr) with V or Mo (which can be activated up to +5 or +6 for a voltage <4.5V), compounds are formed with the potential to activate the +2/+3 couple of the first element as well as the +3/+5 or +3/+6 couples of the second element. More than one lithium per transition metal may be exchanged by the compounds according to some embodiments discussed herein, leading to higher capacities. Some embodiments discussed herein relate to novel mixed compounds with potentially higher energy density than LiFePO₄ and with attractive voltages.

The invention also relates to methods of preparing the electrode materials described herein. Synthesis techniques are presented herein which result in novel compounds with improved energy density and voltages.

One aspect described herein relates to a compound of overall formula LiₐMₓM′_{y}X, wherein M is an element from the group [Fe, Mn, Cr, Co, Ni, Zn, Mg] or a combination of elements from this group; M′ is an element from the group [Mo, V] or a combination of elements from this group; X is a phosphate-comprising chemical group; x+y has a value between 0.9 and 1.1; and a has a value between 0 and 2x+y.

In some embodiments, the compound of overall formula LiₐMₓM′_{y}X is at least partly in a crystalline form. In some embodiments, the compound includes crystals having both M and M′ in the same crystal structure. In some embodiments, the crystals have a formula which is approximately the same as the overall formula.

In some embodiments, a has a value between 0.9 and 1.1. In some embodiments, x+y has a value of 1. In some embodiments, x has a value between 0.3 and 0.7. In some embodiments, x has a value of approximately 0.5.

In some embodiments, M is a single element from the group [Fe, Mn, Cr, Co, Ni, Zn, Mg]. In some embodiments, M″ is a single element from the group [Mo, V]. In some embodiments, X is P₂O₇, PO₄F or PO₄(OH) or a mixture of these chemical groups.

In some embodiments, M′ is vanadium, wherein x and y both have a value of 0.5, wherein M is cobalt and wherein X is PO₄F or PO₄(OH). In some embodiments, M′ is molybdenum, wherein x and y both have a value of 0.5, wherein M is a single element from the group [Co, Ni, Zn, Mg] and wherein X is PO₄F.

Another aspect described herein relates to a rechargeable battery having an electrode which contains a compound according to any of the aspects and/or embodiments described in the paragraphs above (e.g., a compound of overall formula LiₐMₓM′_{y}X, wherein M is an element from the group [Fe, Mn, Cr, Co, Ni, Zn, Mg] or a combination of elements from this group; M′ is an element from the group [Mo, V] or a combination of elements from this group; X is a phosphate-comprising chemical group; x+y has a value between 0.9 and 1.1; and a has a value between 0 and 2x+y).

Another aspect described herein relates to a formulation for use in the manufacture of an electrode of an electrochemical cell, wherein the formulation includes a compound according to any of the aspects and/or embodiments described in the paragraphs above (e.g., a compound of overall formula LiₐMₓM′_{y}X, wherein M is an element from the group [Fe, Mn, Cr, Co, Ni, Zn, Mg] or a combination of elements from this group; M″ is an element from the group [Mo, V] or a combination of elements from this group; X is a phosphate-comprising chemical group; x+y has a value between 0.9 and 1.1; and a has a value between 0 and 2x+y). In some embodiments, the electrode of the formulation is a positive electrode and the electrochemical cell is or forms part of a rechargeable battery.

Yet another aspect described herein relates to a use of a compound according to any of the aspects and/or embodiments described above (e.g., a compound of overall formula LiₐMₓM′_{y}X, wherein M is an element from the group [Fe, Mn, Cr, Co, Ni, Zn, Mg] or a combination of elements from this group; M′ is an element from the group [Mo, V] or a combination of elements from this group; X is a phosphate-comprising chemical group; x+y has a value between 0.9 and 1.1; and a has a value between 0 and 2x+y). In some embodiments, the electrode is a positive electrode and the electrochemical cell is or forms part of a rechargeable battery. In some embodiments, the method of use is directed to storage of electrical energy.

Another aspect described herein relates to a method for preparing a compound according to any of the aspects and/or embodiments described above, wherein atoms M and atoms M′ are brought together with a source of Li atoms and a source of phosphate-containing chemical groups and reacted to form the compound (e.g., a compound of overall formula LiₐMₓM′_{y}X, wherein M is an element from the group [Fe, Mn, Cr, Co, Ni, Zn, Mg] or a combination of elements from this group; M′ is an element from the group [Mo, V] or a combination of elements from this group; X is a phosphate-comprising chemical group; x+y has a value between 0.9 and 1.1; and a has a value between 0 and 2x+y).

In some embodiments, a mixed aqueous solution of M, M′, Li and phosphate in the desired proportions is prepared, after which this aqueous solution is subjected to high temperature and high pressure conditions causing the formation of the compound.

In some embodiments, the high temperature is higher than 200° C. and the high pressure is equal to or higher than the vapour pressure of water at that temperature. In some embodiments, one or several solid salts of M and one or several salts of M′ are brought together with Li₃PO₄ and ball milled together, followed by raising the temperature of the ball milled mixture to a high temperature. In some embodiments, the high temperature is at least 700° C.

In some embodiments, the one or several solid salts of M are oxides or fluorides of M and wherein the one or several solid salts of M′ are oxides or fluorides of M′. In some embodiments, after the temperature of the mixture has been raised to said high temperature, the resulting material is subjected to a treatment with a solvent in order to remove impurities from the mixture.

In some embodiments, the compound is thermodynamically stable. In some embodiments, thermodynamic stability is evaluated according to the method set out in ‘Chemistry of Materials, 2008, Vol. 20, pp. 1798-1807’ and whereby the compound is considered thermodynamically stable if the parameter ‘energy above the hull’ resulting from said method equals 0.

In some embodiments, the compound is capable of exchanging 2x+y lithium atoms per molecule of the compound at a voltage between 2V and 4.5V.

In some embodiments, the compound also includes a dopant. In some embodiments, the dopant is selected from the group consisting of nickel, cobalt, manganese, iron, titanium, copper, silver, magnesium, calcium, strontium, zinc, aluminum, chromium, gallium, germanium, tin, tantalum, niobium, zirconium, fluorine, sulfur, yttrium, tungsten, silicon, and lead. The description of elements of the embodiments above can be applied to this aspect of the invention as well.

In some embodiments, the compound is a member selected from the group consisting of [LiFe_{0.5}V_{0.5}(PO₄)F, LiCo_{0.5}V_{0.5}(P₂O₇), LiFe_{0.5}Mo_{0.5}(PO₄)F, LiMn_{0.5}Mo_{0.5}(PO₄)(OH), LiMn_{0.5}V_{0.5}(PO₄)F, LiMn_{0.5}V_{0.5}(PO₄)(OH), LiMn_{0.5}Mo_{0.5}(PO₄)F, LiZn_{0.5}Mo_{0.5}(PO₄)F, LiMg_{0.5}Mo_{0.5}(PO₄)F].

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

While the invention is particularly shown and described herein with reference to specific examples and specific embodiments, it should be understood by those skilled in the art that various changes in form and detail may be made therein without departing from the spirit and scope of the invention.

FIG. 1 is a plot of average velocity versus capacity for different redox couples in phosphates. The voltages were obtained computationally through high-throughput GGA+U computations while the capacity corresponds to the maximum capacity achievable. This figure is reproduced from Hautier et al., Chemistry of Materials 2011, 23, 3945-3508.

FIG. 2 is a plot of computed voltages for different redox couples active in LiM(P₂O₇) (triangles), LiM(PO₄)F (diamonds), and LiM(PO₄)(OH) structures (circles). The average voltage for delithiation in phosphates (i.e., compounds containing a P⁵⁺ ion) is also indicated by a black cross. The dashed line in the middle of FIG. 2 indicates the approximate voltage stability limit in commercial electrolyte.

FIG. 3 is a scheme for the transition metal mixing strategy. The mixing of Mn and V on the transition metal site of LiM(P₂O₇) is taken as an example. All the illustrated voltage values are from GGA+U computations.

FIG. 4 is a voltage versus capacity plot for pure and mixed compounds (LiM_{0.5}V_{0.5}X (with X═P₂O₇, PO₄(OH), or PO₄F)). Tavorites LiMPO₄F are illustrated with the diamond mark, LiMPO₄(OH) are illustrated with the circle mark, and LiMP₂O₇ are illustrated with the triangle mark. Single transition metal compounds are marked by their transition metal, and mixed compounds are marked by the two mixed transition metals separated by a dash (e.g., Fe—V, Mn—V). Isolines of specific energy are illustrated as three curved lines in FIG. 4. In FIG. 4, the average voltage was plotted when the voltage profile contained several voltage steps. The specific voltage steps may be obtained in Table 2 below.

FIG. 5 is a voltage versus capacity plot for pure and mixed compounds (LiM_{0.5}Mo_{0.5}X (with X═P₂O₇, PO₄(OH), or PO₄F)). Tavorites LiMPO₄F are illustrated with the diamond mark, LiMPO₄(OH) are illustrated with the circle mark, and LiMP₂O₇ are illustrated with the triangle mark. Single transition metal compounds are marked by their transition metal, and mixed compounds are marked by the two mixed transition metals separated by a dash. Isolines of specific energy are illustrated as three curved lines in FIG. 5. In FIG. 5, the average voltage was plotted when the voltage profile contained several voltage steps. The specific voltage steps may be obtained in Table 3 below.

FIG. 6 is a plot of critical oxygen chemical potential versus theoretical specific energy for the charged state of some known cathode materials (black squares) and for the proposed mixed transition metals compounds (diamond for LiM(PO₄)F compounds, circles for LiM(PO₄)(OH), and triangles for LiMP₂O₇). The known compounds are LiMn₂O₄ spinel, LiMnPO₄, and LiFePO₄ olivine, LiFeSO₄F tavorite, and the layered LiCoO₂ and LiNiO₂. Materials with a high oxygen chemical potential for oxygen release are less thermally stable. All the results shown in FIG. 6 are from GGA+U computations. The black dashed line is a visual guide. A new material on the right of this visual guide indicates an improvement in thermal stability in the charged state or in specific energy compared to known materials.

### DESCRIPTION

It is contemplated that apparatus, articles, methods, and processes of the claimed invention encompass variations and adaptations developed using information from the embodiments described herein. Adaptation and/or modification of the apparatus, articles, methods, and processes described herein may be performed by those of ordinary skill in the relevant art.

Throughout the description, where apparatus and articles are described as having, including, or comprising specific components, or where processes and methods are described as having, including, or comprising specific steps, it is contemplated that, additionally, there are apparatus and articles of the present invention that consist essentially of, or consist of, the recited components, and that there are processes and methods according to the present invention that consist essentially of, or consist of, the recited processing steps.

It should be understood that the order of steps or order for performing certain actions is immaterial so long as the invention remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim.

In this paper, a strategy for designing multi-electron materials active in the voltage stability window of commercial electrolyte by mixing two transition metals in a crystal structure possessing adequate sites for activating a +2/+4 couple. By mixing one transition metal with a +2/+3 couple active in a voltage window of 2 to 4.5V (e.g., Co, Fe, Mn or Cr) with V or Mo (which can be activated up to +5 or +6 for a voltage <4.5V), compounds can be formed with the potential to activate the +2/+3 couple of the first element as well as the +3/+5 or +3/+6 couples of the second element. More than one lithium per transition metal could therefore be theoretically exchanged, leading to higher theoretical capacities.

After describing in details the mixing strategy and its application to a few phosphate-based structures, state of the art ab initio computations (Nanjundaswamy, K., et al., Solid State Ionics 1996, 92, 1-10 and Ceder, G., et. al., MRS Bulletin 2011, 36, 185-191), are used to compute the stability and voltage of those designed compounds as well as their theoretical specific energies, energy densities, and thermal stability in the charged state. From this analysis, a few novel mixed compounds with potentially higher energy density than LiFePO₄ and with attractive voltages are discussed and proposed.

All ab initio computations were performed in the density functional theory (DFT) framework using a generalized gradient approximation (GGA) functional parametrized by Perdew-Burke and Ernzerhof (PBE) (Perdew, J., et al., Physical Review letters 1996, 77, 3865-3868). The transition metals, Fe, Cr, Co, Mn, V, and Mo, have been assigned a U parameter to correct for the self-interaction error present in GGA. This U parameter was fitted to experimental binary oxides formation energies from the Kubaschewski tables following the approach of Wang et al. (Wang, L., et al., Physical Review B 2006, 73, 195107; and Kubaschewski, O., et al., Thermochemical Data In Materials Thermochemistry, sixth ed.; Pergamon Press, 1993; Chapter 5, pp. 257-323).

For Cobalt, a U of 5.7 eV was used. All compounds were initialized in their ferromagnetic states with a k-point density of at least 500/(number of atom in unit cell) k-points. Previous work on fluoro-tavorites (Mueller, T., et al., Chemistry of Materials 2011, 23, 3854-3862) and anti-ferromagnetic computations on LiₓMPO₄(OH) and LiₓMP₂O₇ (with x=0, 1, 2 and M=Mn, Fe, Co, V, Mo, Cr) showed that the difference in energy between the anti-ferromagnetic and ferromagnetic configuration was small (less than 7 meV/atom).

The Vienna ab initio software package (VASP) was used with plane-augmented wave (PAW) pseudopotentials. The computations were expected to be converged within a few meV/atom. All VASP computations were run using the AFLOW code (Curtarolo, S. et al., Computational Materials Science 2012, 58, 227-235) and more details on the high-throughput ab initio methodology and parameters can be found in Jain et al., Computational Materials Science 2011, 50, 2295-2310, which is incorporated herein by reference in its entirety.

Thermodynamic stability was evaluated using ab initio computed total energies. The stability of any phase was evaluated by comparing it to other phases or linear combination of phases leading to the same composition using the convex hull construction. The stability analysis was performed versus all compounds present in the ICSD database plus a set of phosphates predicted in Hautier, G. et al., Chemistry of Materials 2011, 23, 3945-3508. GGA and GGA+U computations were combined using Jain et al.'s methodology (Jain et al., Physical Review B 2011, 84, 045115). The stability of any compound was quantified by evaluating the energy above the hull, which represents the magnitude of a compound's decomposition energy. An energy above the hull is always positive and measures the thermodynamic driving force for the compound to decompose into a set of alternative phases. A thermodynamically stable compound has an energy above the hull of 0 meV/atom as it is part of the convex hull of stable phases.

The voltage versus a lithium metal anode associated with the extraction of lithium from the material was computed using the methodology presented in Aydinol et al., J. Physical Review B 1997, 56, 1354-1365. The entropic contribution to the voltage was neglected.

When the specific ordering of lithium (i.e., for partial delithiations) was unknown, an enumeration ordering algorithm similar to the one developed by Hart et al., Physical Review B 2008, 77, 224115 was used, and the ordering associated with the lowest electrostatic energy was chosen to be that computed by an Ewald sum in the same reference.

Potential lithium insertion sites were identified using a dense grid search of the potential energy surface generated by an electrostatic potential model. This potential model was derived from the bond valence method and is similar to the one recently developed by Adams, S, and Rao, R. P., Physical chemistry chemical physics: PCCP 2009, 11, 3210-6.

Safety or thermal stability was computed as in Ong et al., Electrochemistry Communications 2010, 12, 427-430 by evaluating the oxygen chemical potential necessary for the compound to decompose at equilibrium through oxygen gas evolution. This approach assumes an equilibrium process and an entropic contribution to the reaction solely from the oxygen gas. The oxygen chemical potential reference (μO₂=0 meV) was chosen to be air at 298K according to the tabulated entropy of oxygen in the JANAF tables and the fitted oxygen molecule energy from Wang et al., Physical Review B 2006, 73, 195107 and Chase, M. W., NIST-JANAF Thermochemical Tables; American Institute of Physics: Woodbury, N.Y., 1998. Oxygen chemical potential ranges (with respect to this reference) can be found for typical binary oxides in the supplementary information of Hautier et al., Chemistry of Materials 2010, 22, 3762-3767.

### Limits of Singe Transition Metal Phosphates in Terms of Two-Electron Couples

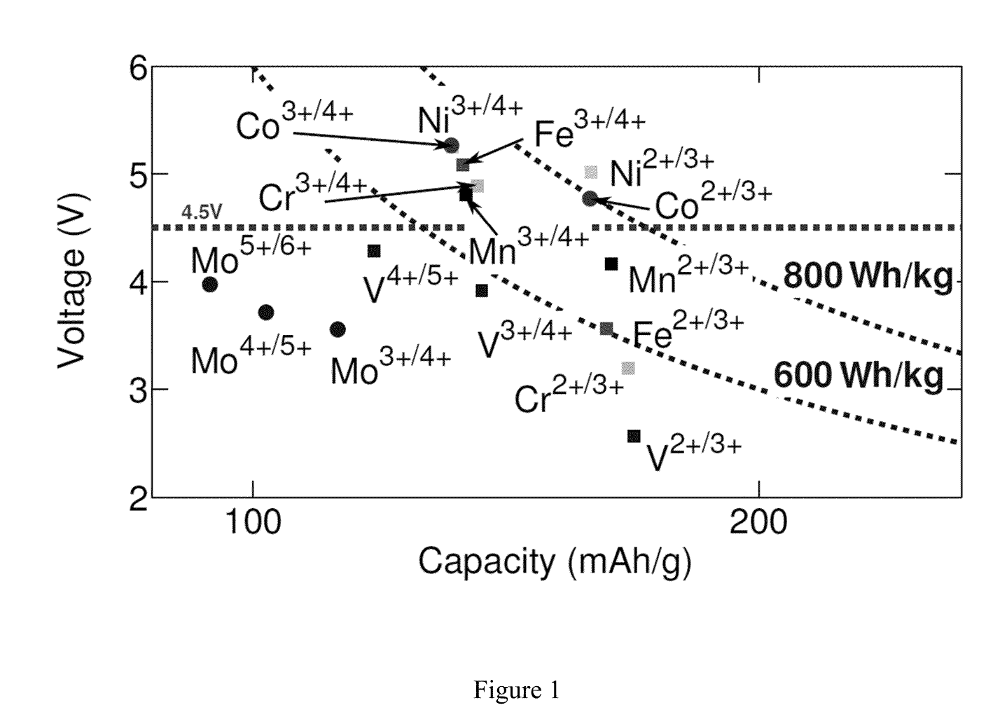

FIG. 1 shows the computed average voltage expected from delithiation of a relatively stable compound versus the maximum gravimetric capacity achievable in phosphates for one-electron cathodes. Each data point corresponds to a redox couple and the limit for commercial electrolyte stability around 4.5V is indicated as a dashed horizontal line. Dashed lines of iso-specific energy (600 Wh/kg and 800 Wh/kg) are also drawn. The most common phosphate cathode material, LiFePO₄ olivine, has a specific energy around 600 Wh/kg.

From FIG. 1, it can be observed that it will be difficult to beat the gravimetric capacity of LiFePO₄ (i.e., 170 mAh/g) with a one-electron phosphate cathode. Increasing the specific energy can be achieved by using electrodes with similar capacity and higher voltage than LiFePO₄ but keeping the voltage in a reasonable range. The Mn²⁺/Mn³⁺ couple is an ideal target for this purpose but LiMnPO₄ has not yet demonstrated satisfactory electrochemical performances to enable commercialization.

Other olivine based materials such as LiNiPO₄ and LiCoPO₄ show voltages significantly higher than 4.5V, but are likely to be limited by the stability of the electrode and the high oxidation strength of the charged cathodes. An alternative strategy to raise the specific energy is to use multi-electron systems. From FIG. 1, it can be observed that it would be difficult to find a +2/+4 couple for which both the +2/+3 and +3/+4 couples are active in the 3 to 4.5V window. For a given element, either the +2/+3 couple is of interest but the +3/+4 couple tends to be too high in voltage (e.g., Fe, Mn, Co or Cr), or the +3/+4 couple is lower than 4.5V but the +2/+3 couple is very low (e.g., V and Mo).

This voltage issue is one of the fundamental difficulties in the development of high capacity +2/+4 phosphates-based cathodes (e.g., Li₂FeP₂O₇, Li₂MnP₂O₇, Li₂FePO₄F, and Li₂CoPO₄F). Only in certain rare crystal structures can the Mn³⁺/Mn⁴⁺ couple be active at a voltage lower than 4.5V as in the recently proposed Li₃Mn(CO₃)(PO₄) carbonophosphate (e.g., as discussed in Hautier, G., et al., Physical Review B 2012, 85, 155208; Chen, H., et al., Chemistry of Materials 2012, 24, 2009-2016; and Chen, H., et al., Journal of the American Chemical Society 2012, 134, 19619-19627).

On the other hand, vanadium and molybdenum-based compounds suffer from lower maximal gravimetric capacity as one-electron couples but have a unique potential for multi-electron activity in phosphates (i.e., Mo³⁺/Mo⁶⁺ and V³⁺/V⁵⁺) within a 3 to 4.5V voltage window. Some previous studies focused on the vanadium chemistries, (e.g., Li₃V₂(PO₄)₃ NASICON, Li₅V(PO₄)₂F₂, and Li₉M₃(P₂O₇)₃(PO₄)₂ with M=V or Mo), but a vanadium or molybdenum-based two-electron cathode with a crystal structure allowing, high capacity, fast and highly reversible Li extraction and insertion has not been found yet.

Computed Voltages and Stability of LiMX Compounds with X═PO₄F, PO₄(OH) or P₂O₇

The voltage mismatch between +2/+3 and +3/+4 couples in phosphates is unfortunate as it excludes from practical applications several known phosphate-based crystal structures that have been shown to be electrochemically active for reversible lithium insertion using a +2/+3 couple as well as for delithiation using the +3/+4 couple. There are several crystal structures of general formula LiMX (with X PO₄F, PO₄(OH) or P₂O₇, where M is a +3 redox active metal) that have been shown to accommodate a significant amount of Li during insertion (LiMX+xLi→Li₁₊ₓMX) as well as allowing topotactic delithiation without major structural instability (LiMX→Li_{1-y}MX+yLi). For the fluorophosphate tavorite LiMPO₄F, reversible processes have been demonstrated for the insertion reaction in the iron, titanium and vanadium forms and for delithiation in the titanium and vanadium forms. Similarly, the tavorite hydroxyphosphate LiM(PO₄)(OH) can insert one Li as shown recently in the iron version (Padhi, A., et al., Electrochem. Soc. 1997, 144, 1609-1613) and might, with the adequate +3/+4 couple, be delithiated to remove one Li. The LiMP₂O₇ structure, on the other hand, is known to be electrochemically active for the insertion of 0.5 Li per transition metal in LiFeP₂O₇, LiTiP₂O₇ and LiVP₂O₇. In addition, Barker et al., Electrochemical and Solid-State Letters 2005, 8, A285 demonstrated full reversible lithium deintercalation from LiVP₂O₇. While these three structures have adequate Li sites for insertion and delithiation, and could lead to high theoretical capacities if the two sites per transition metals could be used (up to 224 mAh/g for LiM(P₂O₇), 302 mAh/g for LiM(PO₄)(OH), and 299 mAh/g for LiM(PO₄)F), they have so far not been able to deliver this large capacity due to the voltage mismatch of the +2/+3 and +3/+4 couples.

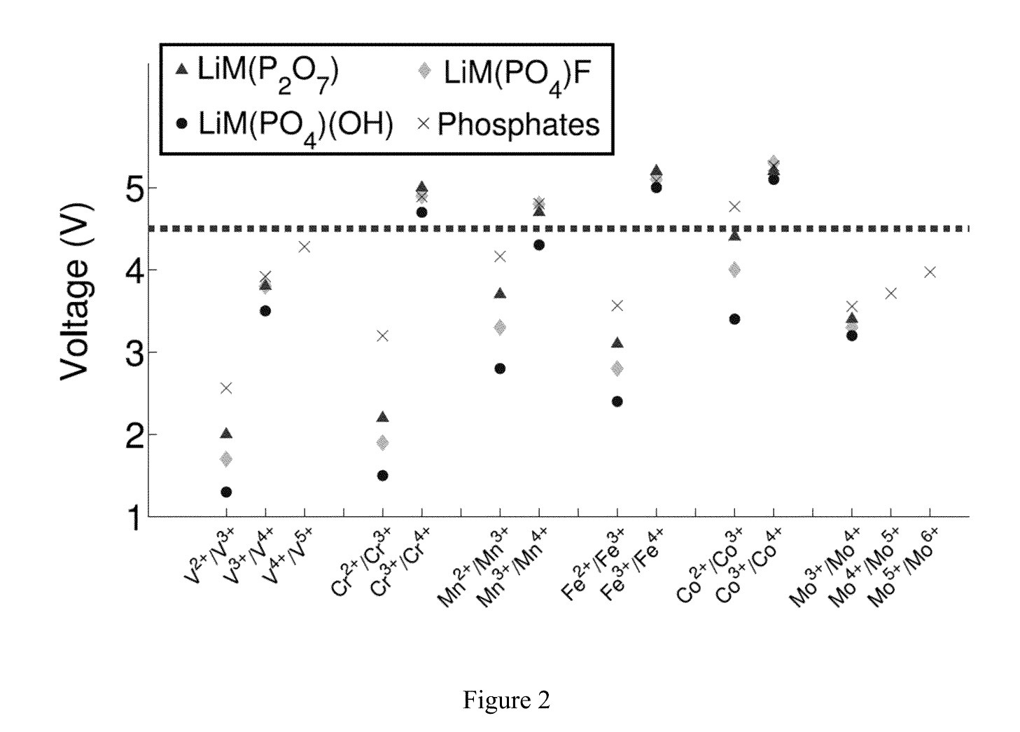

FIG. 2 illustrates the voltage mismatch in those structures by showing the computed voltage for common redox couples in the tavorites LiM(PO₄)F (diamond), LiM(PO₄)(OH) (circle) and pyrophosphates LiM(P₂O₇) (triangle).

For all elements, except Mo and V, the +3/+4 couple is too high in voltage in all structures. On the other hand, vanadium and molybdenum show a very low voltage for their +2/+3 couples, making pure vanadium or molybdenum compounds operate on a low average voltage with a very important voltage step between the two couples. The average voltage obtained on a large pool of phosphates (i.e., compounds belonging to the Li-M-P—O chemical system where M is a redox active element) is also indicated by the black cross in FIG. 2 and the computed voltages are provided in Table 1 below as well.

TABLE 1
Stability of known and predicted +3 compounds in LiM(P₂O₇), LiM(PO₄)F, and LiM(PO₄)(OH).

| | Structure | | Experimental | Energy ab. Hull | Li₁ > Li₂ | Li₁ > Li₀ |
|---|---|---|---|---|---|---|
| Formula | Prototype | Space Group | Information | (meV/atom) | (V) | (V) |
| LiV(P₂O₇) | LiIn(P₂O₇) | P 1 2₁ 1 (4) | 93021 | 0 | 2.0 | 3.8 |
| LiMn(P₂O₇) | LiIn(P₂O₇) | P 1 2₁ 1 (4) | 415153 | 0 | 3.7 | 4.7 |
| LiCr(P₂O₇) | LiIn(P₂O₇) | P 1 2₁ 1 (4) | 240965 | 0 | 2.2 | 5.0 |
| LiFe(P₂O₇) | LiIn(P₂O₇) | P 1 2₁ 1 (4) | 63509 | 0 | 3.1 | 5.2 |
| LiMo(P₂O₇) | LiIn(P₂O₇) | P 1 2₁ 1 (4) | 68522 | 0 | 0.9 | 3.4 |
| LiCo(P₂O₇) | LiIn(P₂O₇) | P 1 2₁ 1 (4) | none | 0 | 4.35 | 5.27 |
| LiV(PO₄)(OH) | LiFe(PO₄)(OH) | P 1̅ (2) | U.S. Pat. | 0 | 1.3 | 3.5 |
| | | | No. 6,964,827 | | | |
| LiMn(PO₄)(OH) | LiFe(PO₄)(OH) | as above | 67495 | 8 | 2.8 | 4.3 |
| LiCr(PO₄)(OH) | LiFe(PO₄)(OH) | as above | none | 0 | 1.5 | 4.7 |
| LiFePO₄(OH) | LiFe(PO₄)(OH) | as above | 250117 | 0 | 2.4 | 5.0 |
| LiMo(PO₄)(OH) | LiFe(PO₄)(OH) | as above | none | 0 | 0.2 | 3.2 |
| LiCo(PO₄)(OH) | LiFe(PO₄)(OH) | as above | none | 0 | 3.4 | 5.1 |
| LiV(PO₄)F | LiAl(PO₄)F | as above | literature⁴⁵ | 0 | 1.7 | 3.8 |
| LiMn(PO₄)F | LiAl(PO₄)F | as above | none | 0 | 3.3 | 4.8 |
| LiCr(PO₄)F | LiAl(PO₄)F | as above | patent⁵³ | 0 | 1.9 | 4.9 |
| LiFe(PO₄)F | LiAl(PO₄)F | as above | literature⁴⁷ | 0 | 2.8 | 5.1 |
| LiMo(PO₄)F | LiAl(PO₄)F | as above | none | 2 | 1.0 | 3.3 |
| LiCo(PO₄)F | LiAl(PO₄)F | as above | none | 0 | 4.0 | 5.3 |

Computed voltages for the insertion of one electron (Li₁>Li₂) and removal of one electron (Li₁>Liₒ) are indicated in Table 1. When previously existing experimental information is present in the ICSD, the ICSD reference number is provided. For compounds with no corresponding entry in the ICSD but information from the literature or patents, the relevant document is referenced. Reference 45 refers to Barker, J., et al., Journal of The Electrochemical Society 2003, 150, A1394. Reference 47 refers to Ramesh, T. N., et al., Electrochemical and Solid-State Letters 2010, 13, A43. The ICSD refers to a LiFe(PO₄)F entry but this entry is from a computational paper and a delithiated structure of Li₂Fe(PO₄)F. Reference 53 refers to Barker, J., et al., Lithium Metal Fluorophosphate and preparation thereof, 2007.

FIG. 2 shows some trends in voltage among the different structures considered. For all +2/+3 couples, the pyrophosphates (triangles) have the highest voltage followed by the fluorophosphates (diamonds) and the hydroxyphosphates (circles). The fluorophosphates are expected to lie higher in voltage due to the influence of fluorine, and the pyrophosphates (P₂O₇ groups) have previously been shown to have slightly higher voltages than orthophosphates (PO₄ groups). As seen in FIG. 2, the +2/+3 couples are all lower in voltage than the average value given in previous high-throughput study (black crosses in FIG. 2). This is consistent with the average values in Hautier, G., et al., Chemistry of Materials 2011, 23, 3945-3508 being from delithiation of a stable +2 compound using the +2/+3 couple, while the +2/+3 voltages according to some embodiments discussed herein are obtained by insertion into a stable +3 compound. As the voltage is directly proportional to the difference in energy between the charged (delithiated) and discharged (lithiated) state, compounds that are stable in their charged state will show lower voltages than compounds stable in their discharged states, for the same redox couple.

The computed voltages can be compared to experiments for the few compounds with reported electrochemical measurement. Insertion in the LiM(P₂O₇) structure has been reported experimentally at 2.0V for vanadium (Uebou, Y. Solid State Ionics 2002, 148, 323-328), and at 2.9V for iron (Padhi, A., et al., J. Electrochem. Soc. 1997, 144, 1609-1613). Both of these experimentally reported values are in agreement with the values computed herein of 2.0V and 3.1V, respectively. The delithiation of the LiV(P₂O₇) compound is on the other hand reported between 4.1 and 4.0V. This is slightly higher than the computed value of 3.8V (Barker, J., et al., Electrochemical and Solid-State Letters 2005, 8, A285).

The manganese version of the pyrophosphate, LiMn(P₂O₇), is known but no electrochemistry has been so far reported on this material. The chromium pyrophosphate, LiCr(P₂O₇) was reported electrochemically active for the Cr³/Cr⁴ couple between 3.1 and 3.5V (Bhuvaneswari, G. D.; Kalaiselvi, N. Applied Physics A 2009, 96, 489-493), which is in disagreement with the computations (5 V). However, the experimental study did not prove that the electrochemical process was the result of topotactic insertion. Marx et al. (Dalton transactions (Cambridge, England: 2003) 2010, 39, 5108-5116) measured insertion into LiFe(PO₄)(OH) between 2.6V and 2.3V in agreement with the presently computed value of 2.4V and reported no activity up to 4.7V for the delithiation (activation of the Fe³/Fe⁴ couple) in agreement as well with the presently computed value of 5V.

The iron version is the only hydroxyphosphate tavorite with a reported electrochemical measurement. The vanadium LiV(PO₄)(OH) has been patented as a cathode by Barker et al. in U.S. Pat. No. 6,964,827 but no report on this material is present in the scientific literature. No report of delithiation or insertion could be found for the known LiMn(PO₄)(OH); only lithium diffusion measurement exists (as evidenced by, e.g., Aranda, M., et al., Angewandte Chemie International Edition in English 1992, 31, 1090-1092; Aranda, M. et al., J. Solid State Ionics 1993, 65, 407-410; and Aranda, M. Journal of Solid State Chemistry 1997, 132, 202-212). From the three families studied, the fluorophosphates tavorites are by far the ones receiving the most interest from the battery community.

Ramesh et al. (Electrochemical and Solid-State Letters 2010, 13, A43) reported electrochemical Li insertion into LiFe(PO₄)F at 2.9V in agreement with the presently computed voltage of 2.8V. The voltages for vanadium tavorite LiV(PO₄)F have been measured at 4.2V for the delithiation and 1.8V for insertion. While the insertion value is close to the computed value of 1.7V, the computed voltage for delithiation underestimates by 0.4V the experimental value which is larger than the usual GGA+U error. All the values obtained experimentally herein are consistent with previous computational work on tavorites discussed in Mueller, T, et al., Chemistry of Materials 2011, 23, 3854-3862.

In addition to providing interstitial sites for Li insertion, and stability upon lithium removal, the tavorites LiM(PO₄)F and LiM(PO₄)(OH) as well as the LiM(P₂O₇) structures are very common and are stable for almost any +3 redox active transition metal. Table 1 shows the energy above the hull (i.e., the energy for decomposition to more stable phases at zero K) for V, Mn, Cr, Fe, Co and Mo in the three structures of interest. Some of these compounds are not present in the inorganic crystal structure database (ICSD) and might never have been synthesized before, but all of them are within 10 meV/atom from decomposition to other phases which is well within the typical DFT error.

### Transition Metals Mixing Strategy to Increase Theoretical Capacity

In some embodiments, an idea of particular interest behind the mixing strategy is to form LiM_{0.5}M′_{0.5}X compounds (with X=P₂O₇, PO₄(OH), or PO₄F, and M=Fe, Mn, Cr, or Co, and M′=V or Mo) in crystal structures known to be good intercalation cathodes. By mixing an ionic species that could be reduced to +2 at a high enough voltage (M=Fe³⁺, Mn³⁺, Cr³⁺ or Co³⁺) with an ionic species (M′=V³⁺ or Mo³⁺) capable to be oxidized from +3 to either +5 or +6 at a voltage lower than 4.5V (see FIG. 2), a higher capacity can be achieved than for the compounds composed of one active element. Indeed, using the possibility for V³⁺ and Mo³⁺ to oxidize up to V⁵⁺ and Mo⁵⁺ at moderate voltage, full deintercalation of the LiM_{0.5}M′_{0.5}X solid solution can be expected through:

Li(M³⁺)_{0.5}(M′³⁺)_{0.5}X→(M₃₊)_{0.5}(M′⁵⁺)_{0.5}X+Li (1)

In addition, lithium insertion through reduction of the M³⁺ species is still possible by:

Li(M³⁺)_{0.5}(M′³⁺)_{0.5}X+0.5Li→Li_{1.5}(M²⁺)_{0.5}(M′³⁺)_{0.5}X (2)

The full reaction corresponds to the exchange of 1.5 electron per transition metal and makes the maximal theoretical capacity achievable (up to 227 mAh/g) higher than when using a one-electron couple. This strategy addresses the problem that these structures only accommodate M²⁺/M³⁺/M⁴⁺ cations when made with a single metal but that no transition metal has an appropriate +2/+3 and +3/+4 redox couple. By combining the high voltage two-electron redox activity of V or Mo with a single electron of a +2/+3 couple, high capacity in a reasonable voltage range can be achieved.

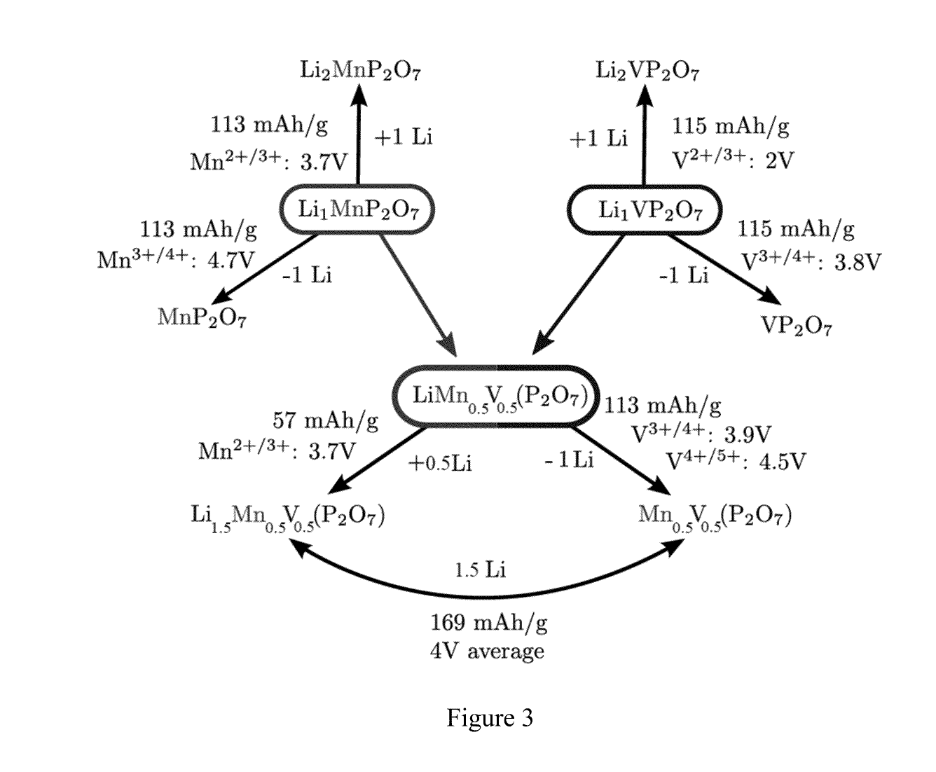

The mixing process is illustrated in FIG. 3 for LiM(P₂O₇) as an example. Individually, the manganese and vanadium compounds suffer from limited useful capacity. Delithiation from the manganese compound LiMn(P₂O₇) requires too high a voltage (4.7V) and the compound has therefore a limited useful capacity of 113 mAh/g (by insertion of one Li using the Mn²⁺/Mn³⁺ couple). On the other hand, LiV(P₂O₇) could in theory both insert and remove one Li per vanadium. However, the insertion process occurs at low voltage, making two electron capacity only reachable with an important voltage step (1.8V) and with a low average voltage (2.9V). Both these characteristics are detrimental for practical battery cathodes. By mixing Mn and V on the transition metal site and forming LiMn_{0.5}V_{0.5}(P₂O₇), a cathode can be designed with enhanced theoretical capacity (169 mAh/g), lower voltage step (0.8V) and a higher average voltage (4V). By using the Mn²⁺/Mn³⁺, V³⁺/V⁴⁺ and V⁴⁺/V⁵⁺ couples, a theoretical capacity corresponding to a 1.5 electrons per transition metal is achievable.

In summary, the mixing strategy according to some embodiments discussed herein requires a structural framework prone to accommodate multiple lithium per transition metal, a metal active at a high voltage on its 2+/3+ couple (e.g., Mn, Fe or Co) and a metal with a multi-electron couple active at a voltage lower than 4.5V (e.g., V or Mo). By mixing those two active metals in such a crystal structure, cathode materials activating more than one lithium per transition metal in a reasonable voltage range can be designed; these materials can offer significantly higher usable capacities than the single metal compounds.

### Applying the Mixing Strategy to Vanadium-Based Compounds

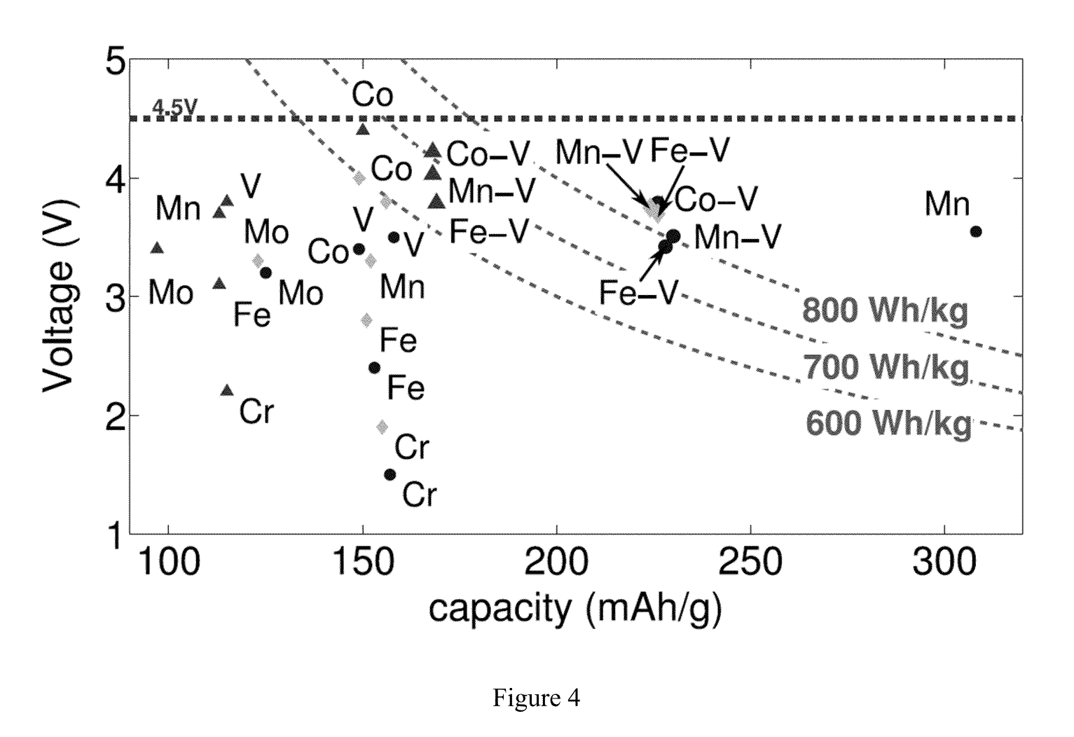

Using the general strategy outlined above, the computational results for mixing of M=Cr, Fe, Mn, Co with vanadium in LiM_{0.5}V_{0.5}X (with X=P₂O₇, PO₄(OH), or PO₄F) are presented herein. FIG. 4 shows a voltage versus capacity plot for the different pure and mixed compounds in the LiMPO₄F (diamond), LiMPO₄(OH) (circle), and LiM(P₂O₇) (triangle) crystal structures. Single transition metal compounds are marked by their transition metal. The average voltage and capacity of mixed transition metal compounds is marked by the two mixed transition metals separated by a dash. Isolines of specific energy are drawn in dashed lines marked with 600 Wh/kg, 700 Wh/kg, and 800 Wh/kg. Only capacities deliverable with a computed voltage lower than 4.6V and with voltage steps <2V are included in the figure. Most pure compounds do not show high enough capacity to reach specific energies of interest (>600 Wh/kg, as in LiFePO₄) but the mixed transition metal compounds can lead to higher specific energies.

The only single transition metal compound with a potential for high specific energy in the 2V to 4.5V voltage window is LiMn(PO₄)OH (marked with a circle, Mn at 300 mAh/g). Only in this compound, is the +31+4 couple low enough to not compromise the electrolyte stability (4.3V) while the +2/+3 couple stays relatively high at 2.8V (see FIG. 2). No electrochemical testing for this known material has been previously reported. Only structural and Li diffusion experimental data is currently available.

The pyrophosphate-based compounds show lower capacities than the tavorites fluoro and hydroxyphosphates. This is due to the smaller charge to mass ratio of the P₂O₇ group compared to PO₄F and PO₄(OH). For all chromium-based mixtures, the Cr²⁺/Cr³⁺ is so close in voltage to the V²⁺/V³⁺ couple that it does not perform significantly better than the pure vanadium system. The voltage, specific energy and energy density data is also provided in Table 2 below.

TABLE 2
Computed electrochemical and stability properties for the
different designed LiM_{0.5}V_{0.5}X vanadium-based compounds.

| | E. ab. hull | Voltage (V) | Voltage (V) | Capacity | Specific E. | E. density |
|---|---|---|---|---|---|---|
| Formula | (meV/atom) | (Li₁ > Li_{1.5}) | (Li₁ > Li₀) | (mAh/g) | (Wh/kg) | (Wh/l) |
| LiMn_{0.5}V_{0.5}(P₂O₇) | 6 | 3.62 | 3.95; 4.52 | 169 | 681 | 1911 |
| LiFe_{0.5}V_{0.5}(P₂O₇) | 0 | 3.01 | 3.91, 4.46 | 169 | 640 | 1826 |
| LiCr_{0.5}V_{0.5}(P₂O₇) | 0 | 1.97 | 3.94, 4.48 | 170 | 589 | 1668 |
| LiCo_{0.5}V_{0.5}(P₂O₇) | 2.4 | 3.57 | 4.50, 4.50 | 168 | 708 | 2050 |
| LiMn_{0.5}V_{0.5}(PO₄)(OH) | 22 | 2.63 | 3.67, 4.24 | 229 | 804 | 2396 |
| LiFe_{0.5}V_{0.5}(PO₄)(OH) | 0 | 2.16 | 3.51, 4.59 | 228 | 783 | 2370 |
| LiCr_{0.5}V_{0.5}(PO₄)(OH) | 0 | 1.2 | 3.55, 4.72 | 231 | 730 | 2186 |
| LiCo_{0.5}V_{0.5}(PO₄)(OH) | 15 | 2.44 | 4.36, 4.57 | 226 | 858 | 2685 |
| LiMn_{0.5}V_{0.5}(PO₄)F | 20 | 3.19 | 3.7; 4.37 | 226 | 849 | 2668 |
| LiFe_{0.5}V_{0.5}(PO₄)F | 0 | 2.88 | 3.75; 4.48 | 226 | 835 | 2654 |
| LiCr_{0.5}V_{0.5}(PO₄)F | 0 | 1.9 | 3.81, 4.54 | 228 | 780 | 2467 |
| LiCo_{0.5}V_{0.5}(PO₄)F | 5 | 3.29 | 4.4, 4.83 | 223 | 933 | 3023 |

To be of interest, the proposed mixed transition metal compounds need to be stable enough energetically to be synthesizable. While mixing of the transition metals will be promoted by entropic contributions at the high temperatures often used in synthesis, it is of interest to study the energetic component of the mixing. Therefore the energy above the hull for all the mixed transition metal compounds is computed. The energy above the hull indicates the driving force for possible decomposition into more stable phases at zero K. The higher the energy above the hull, the less stable the material is. Stable compounds at zero K have an energy above the hull of 0 meV/atom. Table 2 presents, along with electrochemical property, indications about the stability of the mixed compounds by providing their energy above the hull per atom. Most of the mixtures are energetically favorable with relatively low energies above the hull as expected for the mixing of transition metal forming similar crystal structures. Across the three crystal structures, the least stable mixtures are the manganese-based ones. The unfavorable energetics for Mn and V mixing is quite surprising for two ions with close ionic radius (0.645 Å for Mn³⁺ high-spin and 0.69 Å for V³⁺) and a strong tendency to form similar structures as indicated by data mining. However, even though the pure form of a given Mn³⁺ could be isostructural with the V³⁺ parent compounds, it is possible that the strong Jahn-Teller activity of Mn³⁺ leads to large distortion energy of the octahedra around V³⁺ when both metals are mixed in a structure.

The valence state of the transition metals in the mixed compounds was verified by computing the magnetic moments on vanadium and the other transition metal. For all but cobalt-based compounds, the magnetic moment on vanadium was around 1.9 μB, indicating a V³⁺ oxidation state. In the case of cobalt, the lower magnetic moment on vanadium indicated a V⁴⁺—Co² mixture rather than a V³⁺—Co³⁺. The cobalt-based compounds therefore react by oxidizing the V⁴⁺/V⁵⁺ and the Co²⁺/Co³⁺ couples during delithiation:

Li(CO²⁺)_{0.5}(V⁴⁺)_{0.5}X→(CO³⁺)_{0.5}(V⁵⁺)_{0.5}X+Li (3)

and have the V³⁺/V⁴⁺ couple activated during lithium insertion:

Li(Co²⁺)_{0.5}(V⁴⁺)_{0.5}X+0.5Li→Li_{1.5}(Co²⁺)_{0.5}(V³⁺)_{0.5}X (4)

This influences the voltage profile and explains the very high voltage for the charge profile (4.83V) in LiCo_{0.5}V_{0.5}(PO₄)F due to the activation of Co²⁺ to Co³⁺ and not V⁴⁺ to V⁵⁺.

Comparing the calculated Li extraction voltage of LiVPO₄F (activating V³⁺/V⁴⁺) with experiment, it was found that GGA+U under-predicts the voltage (3.8V instead of 4.2V).

### Applying the Mixing Strategy to Molybdenum-Based Compounds

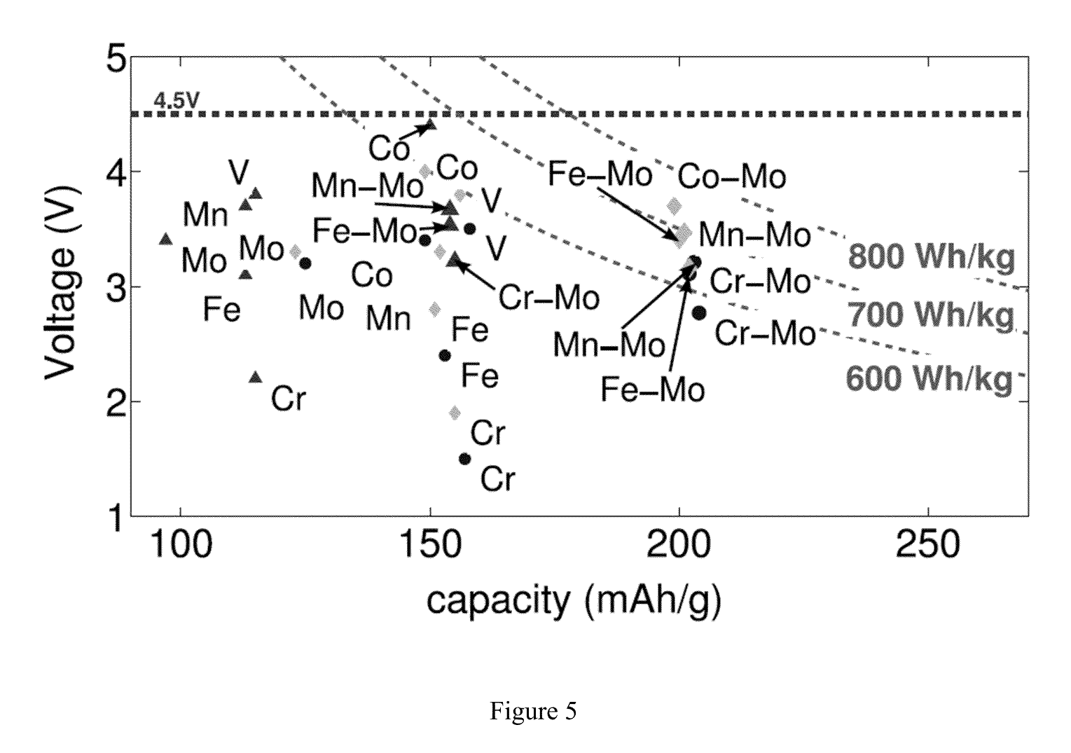

Similarly to vanadium, molybdenum has both the Mo³⁺/Mo⁴⁺ and Mo⁴⁺/Mo⁵⁺ couples fairly close in voltages and below 4.5V in phosphates (see FIGS. 1 and 2). The mixing strategy discussed above was applied to the LiM_{0.5}Mo_{0.5}X (with X═P₂O₇, PO₄(OH), or PO₄F and M=Cr, Fe, Mn, Co) chemistries. FIG. 5 shows a voltage versus capacity plot for the different pure and mixed compounds in the tavorites LiMPO₄F (diamond), LiMPO₄(OH) (circle) and LiM(P₂O₇) (triangle) structures. Isolines of specific energy (600 Wh/kg, 700 Wh/kg, and 800 Wh/kg) are drawn as well. Only capacities deliverable with a computed voltage lower than 4.6V and with voltage steps <2V are included in FIG. 5. Similarly to vanadium, most pure compounds do not show high enough capacity to reach specific energies of interest (>600 Wh/kg, as in LiFePO₄) but the mixed transition metal compounds can lead to higher specific energies.

The larger weight of molybdenum makes the theoretical gravimetric capacities lower than for the equivalent vanadium-based compound. In addition, molybdenum is active at a lower voltage than vanadium. Both those effects gives the molybdenum-based compounds lower specific energies than the vanadium compounds and no mixed pyrophosphate reached more than 600 Wh/kg specific energy. However, the difference between Mo and V is less pronounced when it comes to the volumetric energy densities (Tables 2 and 3).

TABLE 3
Computed electrochemical and stability properties for the
different designed LiM_{0.5}Mo_{0.5}X molybdenum-based compounds.

| | E. ab. hull | Voltage (V) | Voltage (V) | Capacity | Specific E. | E. density |
|---|---|---|---|---|---|---|
| Formula | (meV/atom) | (Liᵢ > Li_{1.5}) | (Li₁ > Li₀) | (mAh/g) | (Wh/kg) | (Wh/l) |
| LiMn_{0.5}Mo_{0.5}(P₂O₇) | 2 | 3.01 | 3.92, 3.92 | 154 | 567 | 1671 |
| LiFe_{0.5}Mo_{0.5}(P₂O₇) | 0 | 3.03 | 3.59, 3.97 | 154 | 544 | 1642 |
| LiCr_{0.5}Mo_{0.5}(P₂O₇) | 0 | 2.1 | 3.6, 3.98 | 155 | 501 | 1584 |
| LiCo_{0.5}Mo_{0.5}(P₂O₇) | 3 | 3.26 | 3.77, 5.0 | 153 | 614 | 1878 |
| LiMn_{0.5}Mo_{0.5}(PO₄)(OH) | 14 | 2.09 | 3.73, 3.83 | 203 | 652 | 2071 |
| LiFe_{0.5}Mo_{0.5}(PO₄)(OH) | 4 | 2.16 | 3.18, 3.98 | 202 | 629 | 2076 |
| LiCr_{0.5}Mo_{0.5}(PO₄)(OH) | 0 | 1.12 | 3.22, 3.97 | 204 | 567 | 1854 |
| LiCo_{0.5}Mo_{0.5}(PO₄)(OH) | 18 | 2.26 | 3.72, 4.70 | 201 | 714 | 2450 |
| LiMn_{0.5}Mo_{0.5}(PO₄)F | 23 | 2.86 | 3.72, 3.86 | 201 | 699 | 2376 |
| LiFe_{0.5}Mo_{0.5}(PO₄)F | 10 | 2.77 | 3.38, 4.09 | 200 | 683 | 2365 |
| LiCr_{0.5}Mo_{0.5}(PO₄)F | 3 | 2.17 | 3.42, 3.89 | 202 | 639 | 2165 |
| LiCo_{0.5}Mo_{0.5}(PO₄)F | 0 | 2.61 | 3.97, 4.54 | 199 | 736 | 2602 |

The valence state of the transition metals in the mixed compounds was verified by computing the magnetic moments on vanadium and the other transition metal. The mixtures of iron, and chromium with molybdenum showed magnetic moments from 1.9 to 2 μB, in agreement with a Mo³⁺ oxidation state. On the other hand, the manganese and cobalt compounds showed a magnetic moment on Mo around 2.8 μB indicating a Mo⁴⁺ oxidation state. An in-vestigation of the change in magnetic moments during delithiation showed in addition that in the case of the Co—Mo compounds, Mo was oxidized up to +6 (with Co staying +2) but on the other hand, in the case of Mn—Mo mixtures, Mo was oxidized up to +5 and Mn was oxidized to +3, in agreement with the higher voltage associated with the Co²⁺/Co³⁺ redox couple compared to the Mn²⁺/Mn³⁺ couple.

The LiCo_{0.5}Mo_{0.5}(PO₄)F compound is of interest even though cobalt is not active (stays +2). By taking advantage of the possibility for Mo to be oxidized higher up to 6+, replacing part of the Mo by the lighter Co can improve the theoretical gravimetric capacity. This alternative design strategy can be extended to other +2 ions such as Mg, Zn, or Ni, and computed data for a few of +4-+2 mixed compounds are presented in Table 4. Both the Ni and Co versions are of great interest in terms of specific energy and energy density but have a voltage associated with the Mo⁵⁺/Mo⁶⁺ couple that is fairly high. Interestingly, the lower stability of the Mg and Zn mixtures (compared to Ni and Co) lowers the voltage associated with the Mo⁴⁺/Mo⁶⁺ couples and makes this Mo⁵⁺/Mo⁶⁺ voltage less likely to compromise electrolyte stability. However, lower mixing stability indicates that the synthesis of the mixed compound might be more difficult and that the risk for cathode decomposition during cycling is higher.

TABLE 4
Computed electrochemical and stability properties for
the different designed Mo⁴⁺-M2+ compounds.

| | E. ab. hull | | Capacity | Specific E. | E. density |
|---|---|---|---|---|---|
| Formula | (meV/atom) | Voltage (V) | (mAh/g) | (Wh/kg) | (Wh/l) |
| LiCo_{0.5}Mo_{0.5}(PO₄)F | 0 | 2.61; 3.97; 4.54 | 199 | 736 | 2602 |
| LiNi_{0.5}Mo_{0.5}(PO₄)F | 0 | 2.56; 4.01; 4.59 | 199 | 741 | 2650 |
| LiZn_{0.5}Mo_{0.5}(PO₄)F | 29 | 2.94; 3.88; 4.18 | 196 | 718 | 2564 |
| LiMg_{0.5}Mo_{0.5}(PO₄)F | 22 | 2.87; 3.9; 4.26 | 218 | 799 | 2610 |

As molybdenum can be oxidized up to +6, the Mo can be reduced to form a compound Li(M³⁺)_{2/3}(Mo³⁺)_{1/3}X where M is Fe or Cr. The Co³⁺ or Mn³⁺ ions cannot be used as they would oxidize Mo³⁺. In these compounds, the +2/+3 redox couple is activated in insertion through:

Li(M³⁺)_{2/3}(Mo³⁺)_{1/3}X+⅔Li→Li_{5/3}(M²⁺)_{2/3}(Mo³⁺)_{1/3}X (5)

The delithiation process can theoretically activate Mo³⁺ to Mo⁶⁺:

Li(M³⁺)_{2/3}(Mo³⁺)_{1/3}X→(M³⁺)_{2/3}(Mo⁶⁺)_{1/3}X+Li (6)

Table 5 presents computed properties for compounds of formula LiM_{2/3}Mo_{1/3}X (with X=P₂O₇, PO₄(OH), or PO₄F and M=Cr, Fe). The lower quantity of molybdenum is favorable to the gravimetric capacity. The results in Table 5 indicate that the Mo⁵⁺/Mo⁶⁺ couples may be too high in voltage in the crystal structures investigated to lead to cathode materials compatible with current electrolyte technology.

TABLE 5
Electrochemical and stability properties for the different
designed LiM_{2/3}Mo_{1/3}X molybdenum-based compounds.

| | E. ab. hull | Voltage (V) | Voltage (V) | Capacity | Specific E. | E. density |
|---|---|---|---|---|---|---|
| Formula | (meV/atom) | (Li₁−>Li_{5/3}) | (Li₁−>Li₀) | (mAh/g) | (Wh/kg) | (Wh/l) |
| LiFe_{2/3}Mo_{1/3}(P₂O₇) | 0 | 3.05, 3.05 | 3.64, 4.01, 5.2 | 175 | 664 | 1958 |
| LiCr_{2/3}Mo_{1/3}(P₂O₇) | 0 | 2.14, 2.14 | 3.64, 4.06, 4.9 | 176 | 596 | 1720 |
| LiFe_{2/3}Mo_{1/3}(PO₄)(OH) | 4 | 2.16, 2.21 | 3.27, 4.02, 4.79 | 231 | 761 | 2396 |
| LiCr_{2/3}Mo_{1/3}(PO₄)(OH) | 1 | 1.23, 1.23 | 3.36, 3.82, 4.85 | 234 | 680 | 2127 |
| LiFe_{2/3}Mo_{1/3}(PO₄)F | 12 | 2.12, 2.89 | 3.44, 4.42, 5.21 | 233 | 829 | 2724 |
| LiCr_{2/3}Mo_{1/3}(PO₄)F | 0 | 1.98, 2.14 | 3.4, 4.09, 4.65 | 232 | 755 | 2463 |

The development of high-capacity phosphate-based cathodes has been impeded by the difficulty of finding compounds with both the +2/+3 and +3/+4 redox couples with adequate voltage. In general, transition metals for which the +3/+4 redox couple is below 4.5V tend to display very low voltages for the +2/+3 redox couple. Therefore, even within crystal structures that are known to separately accommodate Li insertion (+2/+3 redox couple) and Li deinsertion (+3/+4 redox couple), it has been difficult to find a single metal or mixture of metals in a good voltage range. Some embodiments discussed herein relate to a novel strategy whereby the +2/+3 redox couple of one transition metal is combined with either the +3/+5 redox couple of V or the +31+5 or +3/+6 redox couples of Mo. By coupling a single-electron process for one metal with a multi-electron process for the other metal, the overall capacity can be increased past that of a one-electron process while retaining good voltage (3V -4.5V) throughout.

The computational analysis described herein identified several potential novel cathode materials with theoretical specific energy and energy density significantly higher than LiFePO₄, the most developed phosphate cathode material. In Table 6, a list of compounds of greatest interest found by the design strategy in accordance with certain embodiments discussed herein is presented.

Taking a conservative cut-off on the voltage (4.5V) and looking for materials with a specific energy and energy density significantly larger than LiFePO₄ (i.e., >650 Wh/kg and >2000 Wh/l), seven compounds can be found from the strategy of mixing electrochemically active elements according to some embodiments discussed herein; two compounds from an alternative strategy that involves mixing Mo with inactive +2 elements according to some embodiments discussed herein, and one compound previously reported in the literature.

If the constraints on the upper voltage limit are slightly relaxed (increased) to 4.6V, several additional materials become of interest (e.g., LiCo_{0.5}Mo_{0.5}(PO₄)F, LiNi_{0.5}Mo_{0.5}(PO₄)F, LiCo_{0.5}V_{0.5}(PO₄)(OH), LiFe_{0.5}V_{0.5}(PO₄)(OH), and LiMn_{0.5}V_{0.5}(P₂O₇)).

TABLE 6
Stability and electrochemical computed data for the cathode materials of greatest interest.
The mixtures of active elements are sorted by stability of the LiM_{0.5}M′_{0.5}X mixed phase.

| | | | | | |
|---|---|---|---|---|---|
| | E. ab. hull | | Capacity | Specific E. | E. density |
| Formula | (meV/atom) | Voltage (V) | (mAh/g) | (Wh/kg) | (Wh/l) |

Mixtures of active elements

| | | | | | |
|---|---|---|---|---|---|
| LiFe_{0.5}V_{0.5}(PO₄)F | 0 | 2.88; 3.75; 4.48 | 226 | 835 | 2654 |
| LiCo_{0.5}V_{0.5}(P₂O₇) | 2 | 3.57; 4.50; 4.50 | 168 | 708 | 2050 |
| LiFe_{0.5}Mo_{0.5}(PO₄)F | 10 | 2.77; 3.38; 4.09 | 200 | 683 | 2365 |
| LiMn_{0.5}Mo_{0.5}(PO₄)(OH) | 14 | 2.09; 3.73; 3.83 | 203 | 652 | 2071 |
| LiMn_{0.5}V_{0.5}(PO₄)F | 20 | 3.19; 3.7; 4.37 | 226 | 849 | 2668 |
| LiMn_{0.5}V_{0.5}(PO₄)(OH) | 22 | 2.63; 3.67; 4.24 | 229 | 804 | 2396 |
| LiMn_{0.5}Mo_{0.5}(PO₄)F | 23 | 2.86; 3.72; 3.86 | 229 | 699 | 2376 |

Mixtures of active and inactive elements

| | | | | | |
|---|---|---|---|---|---|
| LiZn_{0.5}Mo_{0.5}(PO₄)F | 29 | 2.94; 3.88; 4.18 | 196 | 718 | 2564 |
| LiMg_{0.5}Mo_{0.5}(PO₄)F | 22 | 2.87; 3.9; 4.26 | 218 | 799 | 2610 |

Previously known compounds

| | | | | | |
|---|---|---|---|---|---|
| LiMn(PO₄)(OH) | 8 | 2.8; 4.36 | 296 | 1059 | 3094 |

Among the three crystal structure families investigated, the LiMP₂O₇ pyrophosphates showed the lowest specific energy and energy density. The majority of favorable compounds presented here are hydroxy- and fluorophosphate tavorites. In the non-mixed compounds (Table 1), the presence of fluorine in the LiM(PO₄)F compounds raised the delithiation voltage (on average by 0.23V) compared to LiM(PO₄)OH and by 0.48V on average for insertion (LiMX→Li₂MX). The presence of fluorine raised the voltage due to its higher electronegativity. This fluorine effect was also observed for lithium insertion in the mixed compounds (average increase of 0.72V from the hydroxy to the fluorine-based tavorites).

In the first step of delithiation (LiM_{0.5}M′_{0.5}X→Li_{0.5}M_{0.5}M′_{0.5}X), the voltage of the fluorine tavorites was 0.17V higher than for the hydroxy-tavorites. But surprisingly, it is predicted that the last delithiation step in the mixed compounds (Li_{0.5}M_{0.5}M′_{0.5}X→M_{0.5}M′_{0.5}X) occurs on average at the same voltage for the fluorine and hydroxy tavorites. The average higher voltage in fluorine-based compounds makes the equivalent fluorophosphate often of greater interest in terms of specific energy and energy density. For instance, comparing LiFe_{0.5}Mo_{0.5}(PO₄)F and LiFe_{0.5}Mo_{0.5}(PO₄)OH, the fluorophosphate compound provides higher specific energy and energy density because of the higher voltage in insertion and for the first delithiation step. Of course, other factors not necessarily taken into account herein, such as synthesis conditions, cyclability or rate capability could favor one or the other chemistry. The possibility of synthesizing mixed hydroxy-fluorophosphates could add another design knob of interest.

Among the different +2/+3 redox couples, some embodiments discussed herein show that Cr²⁺/Cr³⁺ is always too low to be of interest in terms of energy density. Mn²⁺/Mn³⁺ and Fe²⁺/Fe³⁺ are similar in terms of voltage, but all the Mn compounds show less favorable mixing energetics with V or Mo.

Comparing the specific energies achievable for vanadium and molybdenum-based compounds, the vanadium compounds outperformed the Mo systems. For instance, the vanadium fluorophosphate, LiFe_{0.5}V_{0.5}(PO₄)F, had one of the largest specific energies among the set of compounds.

It is estimated that a more accurate voltage for the last delithiation step of LiFe_{0.5}V_{0.5}(PO₄)F (i.e. Li_{0.5}Fe_{0.5}V_{0.5}(PO₄)F→Fe_{0.5}V_{0.5}(PO₄)F), would be around 4.89V (computed using a U value of 4.4 eV for vanadium that reproduces the experimental voltage of LiV(PO₄)F).

Hybrid functionals are an alternative approach to GGA+U also designed to correct for the spurious self-interaction present in standard DFT. Recently, the Haynes-Scuseria-Ernzerho (HSE) functional has been shown to perform similarly to GGA+U in predicting voltages but at a higher computational cost. In the specific case of LiV(PO₄)F, using HSE leads to a computed delithiation voltage of 4.16V in very close agreement with experiment (4.2V).

The Mo-based mixed compounds showed a slightly lower voltage and lower gravimetric capacity due to the larger weight of Mo. There are, however, a few very competitive Mo-based compounds in the set described herein. The tavorite fluorophosphate Fe—Mo mixed compound (Li_{0.5}Fe_{0.5}Mo_{0.5}(PO₄)F) is of greatest interest with high stability as a mixture, high specific energy, and energy density (respectively 683 Wh/kg and 2365 Wh/l). While the specific energy is not as competitive as for vanadium, the volumetric energy density is very attractive (25% higher than LiFePO₄).

In addition to compounds developed by mixing active elements, an alternative strategy was also presented involving the mixing of an inactive +2 metal with Mo. While the compound with the most favorable transition metal mixing: LiCo_{0.5}Mo_{0.5}(PO₄)F has a last voltage step (4.54V) in the delithiation profile that could be worrisome for the electrolyte stability, LiMg_{0.5}Mo_{0.5}(PO₄)F was found to have a less favorable mixing tendency but a more attractive last voltage step (4.29V).

In addition to voltage, specific energy, and energy density, the safety of charged cathode materials is paramount. As safety can be linked to the thermal stability versus oxygen release of the charged electrode, a scheme based on DFT computations has been recently developed to evaluate the intrinsic thermal stability of a cathode material by computing the oxygen chemical potential for oxygen release, as discussed in Ong, S. P., et al., Electrochemistry Communications 2010, 12, 427-430. Materials with a high oxygen chemical potential for oxygen release will be less thermally stable. It is known that the targeted oxidation states in the charged cathode during the design according to some embodiments discussed herein (i.e, V⁵⁺, Mo⁵⁺, or Mo⁶⁺) tend to be intrinsically thermally stable and are associated with low chemical potential for oxygen release, as discussed in Hautier, G., et al., Chemistry of Materials 2011, 23, 3945-3508. To verify that safe cathode materials were designed in some embodiments discussed herein, the oxygen chemical potential for oxygen release from all the compounds of greatest interest was computed.

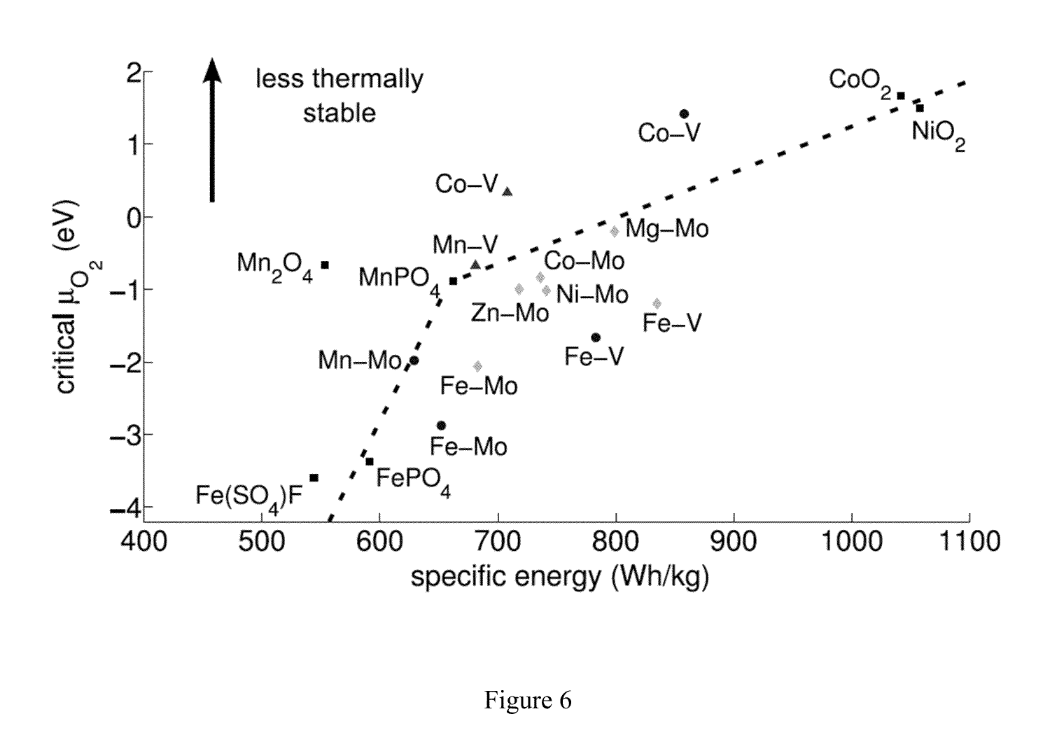

FIG. 6 shows the oxygen chemical potential in the fully delithiated (charged state) versus the specific energy for a few known cathode materials (shown by squares) and for the present compounds present in Table 6 (diamond for LiM(PO₄)F, circles for LiM(PO₄)(OH), and triangles for LiMP₂O₇).

The inverse correlation between specific energy and safety can be directly observed with the safest materials (LiFePO₄) being the lowest in specific energy and the least safe materials (the layered nickel and cobalt oxides) being the highest in specific energy. Higher voltage (and therefore higher specific energies) often implies lower thermal stability. The dashed line in FIG. 6 is a guide to the eye for the current specific energy versus safety trends in cathode materials of current interest. Most of the compounds proposed according to the embodiments discussed herein are situated to the right of the dashed line, and are in the region where higher specific energies are obtained without compromising too much the thermal stability.

Some embodiments discussed herein screened some of the necessary battery properties that indicate a good battery material. Barriers for lithium diffusion are additional important properties in terms of rate capability. Fluorophosphates tavorites (and especially LiVPO₄F) can have very low lithium migration barriers. Therefore, the fluorophosphate compounds discussed in some embodiments (e.g., LiMg_{0.5}Mo_{0.5}(PO₄)F and LiFe_{0.5}Mo_{0.5}(PO₄)F) could form high energy density, high safety, and high rate cathode materials.

In addition to the mixed compounds, one non-mixed compound was found showing, according to computations, a surprising potential for two-electron redox capacity. LiMn(PO₄)(OH) is predicted to be able to insert one Li at a voltage of 2.8V while deintercalating at 4.3V.

The theoretical specific energy and energy density are extremely large and respectively 1065 Wh/kg and 3082 Wh/l. A phosphate-based cathode activating the Mn³⁺/Mn⁴⁺ couple at a potential lower than 4.5V is rare but not impossible as showed by recent work on Li₃Mn(CO₃)(PO₄) (e.g., Hautier, G., et al., Physical Review B 2012, 85, 155208; and Chen, H., et al., Chemistry of Materials 2012, 24, 2009-2016). There are a few prior reports on LiMn(PO₄)(OH) but no electrochemical measurements have been reported.

While the mixing strategy has been illustrated here with specific crystal structures, the approach can be used on other phosphate materials. For instance, the Li₃Mo₂(PO₄)₃ NASICON may be an interesting cathode material with a somewhat low theoretical capacity of 161 mAh/g. On the other hand, Li₃Fe₂(PO₄)₃ NASICON is a well-known material in which 2 additional Li per formula unit can be inserted but cannot be delithiated due to the high voltage of the Fe³⁺/Fe⁴⁺ couple. Using the potential for Mo oxidation up to +6, a Li₃MoFe(PO₄)₃ mixed compound can be proposed—that can be fully delithiated (up to Mo⁶⁺ in MoFe(PO₄)₃) and inserted up to one Li per formula unit (reducing Fe³⁺ to Fe²⁺ and forming Li₄MoFe(PO₄)₃). The capacity of this compound would be around 230 mAh/g.

In addition, the mixing strategy can also be used to develop a variety of new compounds in a variety of chemistries other than phosphates. In some embodiments, the chemistries of special interest are chemistries with high inductive effects that make the +3/+4 couple too high in voltage compared to the electrolyte stability window (e.g., fluoropolyanions, sulfates and fluorides).

Finding phosphates-based multiple-electron cathode materials active within the stability voltage window of commercial electrolytes is challenging. Some embodiments discussed herein relate to a design strategy based on mixing transition metals in crystal structures known to reversibly accommodate Li in insertion and in delithiation. By mixing elements that are electrochemically active at a reasonably high voltage on the +2/+3 couples (e.g., Fe) with element active on the +3/+5 or +3/+6 (i.e., V and Mo) couples within the electrolyte voltage window, it was showed that high capacity multi-electron cathodes can be designed. The mixing strategy according to some aspects discussed herein may be applied to phosphates, fluorophosphates and hydroxyphosphates chemistries (in addition to other chemistries). In some embodiments, several compounds are identified as materials of interest with favorable properties in terms of voltage, specific energy, energy density, and safety.

### EQUIVALENTS

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A compound of overall formula LiₐMₓM′_{y}X, wherein
M is an element from the group [Fe, Mn, Cr, Co, Ni, Zn, Mg] or a combination of elements from this group;
M′ is an element from the group [Mo, V] or a combination of elements from this group;
X is a phosphate-comprising chemical group;
x+y has a value between 0.9 and 1.1; and
a has a value between 0 and 2x+y.

2. The compound according to claim 1, wherein the compound is at least partly in a crystalline form.

3. The compound according to claim 2, wherein the compound comprises crystals having both M and M′ in the same crystal structure.

4. The compound according to claim 3, wherein the crystals have a formula which is approximately the same as the overall formula.

5. The compound according to claim 1, wherein a has a value between 0.9 and 1.1.

6. (canceled)

7. The compound according to claim 1, wherein x has a value between 0.3 and 0.7.

8. (canceled)

9. The compound according to claim 1, wherein M is a single element from the group [Fe, Mn, Cr, Co, Ni, Zn, Mg].

10. The compound according to claim 1, wherein M′ is a single element from the group [Mo, V].

11. The compound according to claim 1, wherein X is P₂O₇, PO₄F or PO₄(OH) or a mixture of these chemical groups.

12. The compound according to claim 1, wherein M′ is vanadium, wherein x and y both have a value of 0.5, wherein M is cobalt and wherein X is PO₄F or PO₄(OH).

13. The compound according to claim 1, wherein M′ is molybdenum, wherein x and y both have a value of 0.5, wherein M is a single element from the group [Co, Ni, Zn, Mg] and wherein X is PO₄F.

14. A rechargeable battery having an electrode which comprises the compound according to claim 1.

15. A formulation for use in the manufacture of an electrode of an electrochemical cell, wherein the formulation comprises the compound according to claim 1.

16. (canceled)

17. Use of the compound according to claim 1 in an electrode of an electrochemical cell.

18. (canceled)

19. (canceled)

20. A method for preparing a compound according to claim 1, wherein atoms M and atoms M′ are brought together with a source of Li atoms and a source of phosphate-containing chemical groups and reacted to form the compound.

21. Method according to claim 20, wherein a mixed aqueous solution of M, M′, Li and phosphate in desired proportions is prepared, after which the mixed aqueous solution is subjected to high temperature and high pressure conditions causing the formation of the compound.

22. (canceled)

23. Method according to claim 20, wherein one or several solid salts of M and one or several salts of M′ are brought together with Li₃PO₄ and ball milled together, followed by raising the temperature of the ball milled mixture to a high temperature.

24-26. (canceled)

27. The compound according to claim 1, wherein the compound is thermodynamically stable.

28. (canceled)

29. The compound according to claim 1, wherein it is capable of exchanging 2x+y lithium atoms per molecule of the compound at a voltage between 2 V and 4.5 V.

30. (canceled)

31. The compound of claim 1, wherein the compound is a member selected from the group consisting of [LiFe_{0.5}V_{0.5}(PO₄)F, LiCo_{0.5}V_{0.5}(P₂O₇), LiFe_{0.5}Mo_{0.5}(PO₄)F, LiMn_{0.5}Mo_{0.5}(PO₄)(OH), LiMn_{0.5}V_{0.5}(PO₄)F, LiMn_{0.5}V_{0.5}(PIO₄)(OH), LiMn_{0.5}Mo_{0.5}(PO₄)F, LiZn_{0.5}Mo_{0.5}(PO₄)F, LiMg_{0.5}Mo_{0.5}(PO₄)F].
